(19) United States
(12) Patent Application Publication
(10) Pub. No.: US 2017/0184886 A1
(43) Pub. Date: Jun. 29, 2017

(54) LIQUID CRYSTAL DISPLAY PANEL AND FABRICATION METHOD THEREOF, AND DISPLAY DEVICE

(71) Applicants: Shanghai Tianma Micro-electronics Co., Ltd., Shanghai (CN); Tianma Micro-electronics Co., Ltd., Shenzhen (CN)

(72) Inventor: YUANYUAN CHEN, Shanghai (CN)

(73) Assignees: Shanghai Tianma Micro-electronics Co., Ltd.; Tianma Micro-electronics Co., Ltd.

(21) Appl. No.: 15/055,785

(22) Filed: Feb. 29, 2016

(30) Foreign Application Priority Data
Dec. 24, 2015 (CN) 2015-10982749.5

(51) Int. Cl. G02F 1/1337; G02F 1/1343

(52) U.S. Cl. CPC G02F 1/1337; G02F 1/134363; G02F 2001/133749

(57) ABSTRACT

A liquid crystal display (LCD) panel, a display device and a fabrication method of the LCD panel are provided. The LCD panel comprises a first substrate, a second substrate opposite to the first substrate, a liquid crystal (LC) layer sandwiched between the first substrate and the second substrate, a first alignment layer disposed on the first substrate, and a second alignment layer disposed on the second substrate. The first alignment layer is in contact with the LC layer and provides a first pre-tilt angle α to LC molecules in the LC layer, and the second alignment layer is in contact with the LC layer and provides a second pre-tilt angle β to the LC molecules in the LC layer, where α>β.

### CROSS-REFERENCES TO RELATED APPLICATIONS

This application claims the priority of Chinese patent application No. 201510982749.5, filed on Dec. 24, 2015, the entire content of which is incorporated herein by reference.

### FIELD OF THE DISCLOSURE

The present disclosure relates to the field of display technology and, more particularly, relates to a liquid crystal display (LCD) panel and related fabrication techniques, and a corresponding display device.

### BACKGROUND

During the fabrication of liquid crystal display (LCD) panels, an alignment layer is often disposed on top and bottom of a liquid crystal (LC) layer, respectively, which provides a pre-tilt angle to each LC molecule in the LC layer. Under an external electric field, the LC molecules can speedily respond to the electric field to reorient or tilt, and visible light emitted from a backlight light source transmits through the LC layer to the outside of the LCD panel accordingly.

Although LCDs have become the mainstream flat panel display technology nowadays, some technical issues still remain to be solved. Image retention or image persistence or image sticking often occurs in LCDs when a fixed pattern or image is displayed over a prolonged period of time, and a faint outline of a previously displayed fixed or semi-fixed image remains visible on the screen even when the image is changed. Image retention is annoying to users as it degrades the image quality, thus highly desired to be minimized or eliminated.

The disclosed LCD display panel and the related fabrication method are directed to solve one or more problems set forth above and other problems.

### BRIEF SUMMARY OF THE DISCLOSURE

One aspect of the present disclosure provides a liquid crystal display (LCD) panel. The LCD panel comprises a first substrate, a second substrate arranged opposite to the first substrate, a liquid crystal (LC) layer sandwiched between the first substrate and the second substrate, a first alignment layer disposed on the first substrate, and a second alignment layer disposed on the second substrate. The first alignment layer is in contact with the LC layer and provides a first pre-tilt angle α to LC molecules in the LC layer, and the second alignment layer is in contact with the LC layer and provides a second pre-tilt angle β to the LC molecules in the LC layer, where α>β.

Another aspect of the present disclosure provides a display device. The display device comprises a LCD panel. The LCD panel comprises a first substrate, a second substrate arranged opposite to the first substrate, a LC layer sandwiched between the first substrate and the second substrate, a first alignment layer disposed on the first substrate, and a second alignment layer disposed on the second substrate. The first alignment layer is in contact with the LC layer and provides a first pre-tilt angle α to LC molecules in the LC layer, and the second alignment layer is in contact with the LC layer and provides a second pre-tilt angle β to the LC molecules in the LC layer, where α>β.

Another aspect of the present disclosure provides a fabrication method of the LCD panel. The method comprises forming a first alignment layer on a first substrate; forming a LC layer on the first alignment layer; and forming a second alignment layer in contact with the LC layer on a second substrate opposite to the first substrate. The first alignment layer provides a first pre-tilt angle α to LC molecules in the LC layer, the second alignment layer provides a second pre-tilt angle β to the LC molecules in the LC layer, where α>β.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates high temperature image retention curves of LCD panels with a high pre-title angle and a low pre-title angle;

FIG. 2 illustrates contrast ratio viewing angle characteristics of LCD panels with a high pre-title angle and a low pre-title angle;

FIG. 3 illustrates a cross-sectional view of an exemplary LCD panel consistent with disclosed embodiments;

FIG. 4a illustrates a first pre-tilt angle provided by a first alignment layer in an exemplary LCD panel in FIG. 3 consistent with disclosed embodiments;

FIG. 4b illustrates a second pre-tilt angle provided by a second alignment layer in an exemplary LCD panel in FIG. 3 consistent with disclosed embodiments;

FIG. 5 illustrates high temperature image retention curves of two LCD panels and an exemplary LCD panel consistent with disclosed embodiments;

FIG. 6a-6c illustrate viewing cones corresponding to contrast ratio Bmin, Amin and A+min;

FIG. 7 illustrates a flow chart of an exemplary LCD panel fabrication process consistent with disclosed embodiments; and

FIG. 8 illustrates a schematic diagram of an exemplary display device consistent with disclosed embodiments

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiments, persons of ordinary skill in the art may derive other embodiments consistent with the present disclosure, all of which are within the scope of the present invention.

A LCD panel often includes two substrates and a LC layer sandwiched between the two substrates. Each substrate is coated with an alignment layer in contact with the LC layer. The LC layer includes a plurality of LC molecules. For example, typical nematic liquid crystal often has rod-like elongated molecules, and the long axis of the rods are often referred as directors of the LC molecules. The alignment layers help to align the directors of the LC molecules in contact with the alignment layers (i.e., LC molecules at the surfaces of the LC layer) in a certain orientation. The angle between the director of the LC molecules and the alignment layer surface may be referred as the pre-tilt angle.

The LC molecules in the bulk of the LC layer may follow the orientation of the LC molecules at the interface between the LC layer and the alignment layer surfaces. That is, ideally the directors of the LC molecules in the LC layer may be parallel to each other, exhibiting a uniform orientation throughout the LCD panel. Thus, all the LC molecules in the LC layer may exhibit a same pre-tile angle at a static state, i.e., without any external voltage applied on the LC layer. However, in the real LCD panel, the pre-tilt angle of the LC molecules may gradually decrease when the distance between the LC molecule and the alignment layer increases.

The image retention may mainly rise from ionic charges accumulated at interface between the LC layer and the alignment layer when the LCD panel has been operated continuously for a long period of time with a fixed image. When the external driving voltage is removed, the ions do not dissipate from the interface immediately, which in turn gives rise to a residual direct current (DC) voltage, resulting in a retention of previously-displayed image. Other factors may also cause the image retention in the LCD panel, because the LCD panel includes many other elements and the LCD panel may be fabricated by different processes.

The image retention may be evaluated by the image retention level, and a higher image retention level may indicate a more severe image retention. The image retention level may be calculated according to a predetermined algorithm.

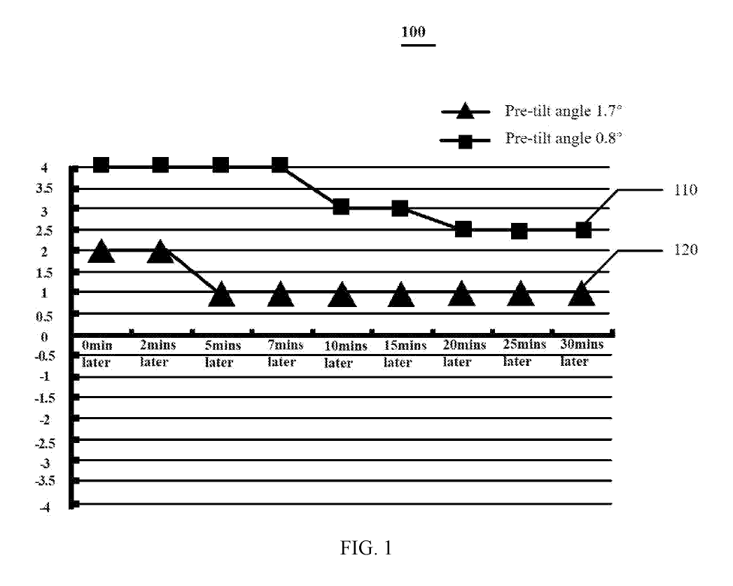

FIG. 1 illustrates high temperature image retention curves of LCD panels with a high pre-title angle and a low pre-title angle. The image retention curves 100 indicate the high temperature (65° C./2 h) image retention levels of two 32-greyscale LCD panels. That is, the image retention curves are measured after the two LCD panels display a black-and-white checkerboard pattern for two hours in a 65° C. environment. As shown in FIG. 1, the horizontal axis indicates the time after the LCD panel stops displaying the black-and-white checkerboard pattern, and the vertical axis indicates the image retention level.

In particular, an image retention curve 110 indicates the high temperature image retention level of the LCD panel consisting of LC molecules with a 0.8° pre-title angle, i.e., the low pre-title angle. An image retention curve 120 indicates the image retention level of the LCD panel consisting of LC molecules with a 1.7° pre-title angle, i.e., the high pre-title angle. A higher image retention level may indicate a more severe image retention.

According to the image retention curve 110 and the image retention curve 120, the LCD panel consisting of LC molecules with the low pre-title angle (0.8° pre-title angle) may always have a higher image retention level than the LCD panel consisting of LC molecules with the high pre-title angle (1.7° pre-title angle). However, as the pre-tilt angle increases, the viewing angle of the LCD panel is reduced.

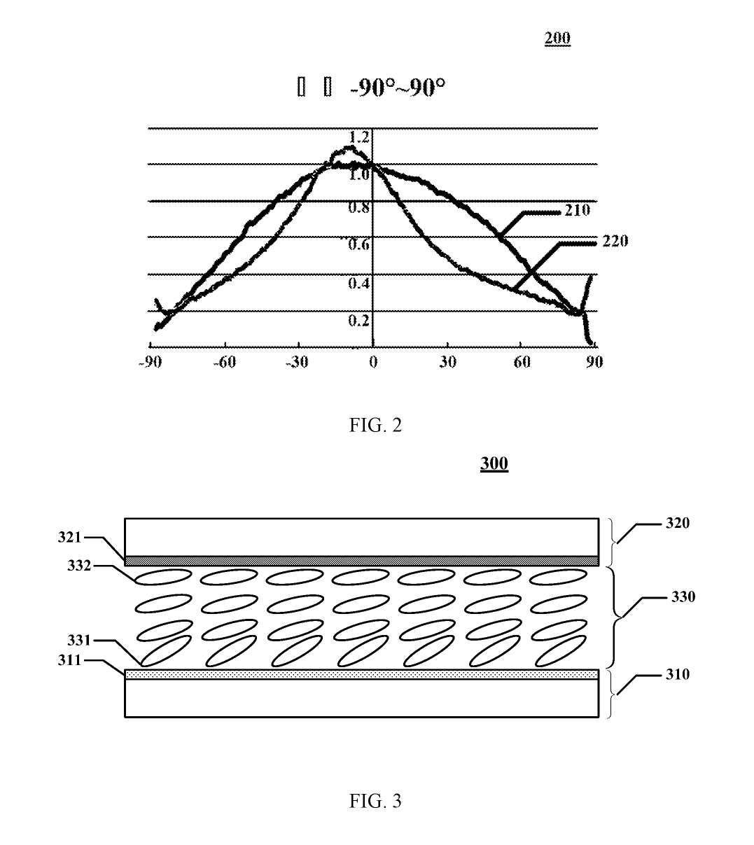

FIG. 2 illustrates contrast ratio viewing angle characteristics of LCD panels with a high pre-title angle and a low pre-title angle. As shown in FIG. 2, the horizontal axis indicates the viewing angle, and the vertical axis indicates the normalized contrast ratio. The contrast ratio is measured within a viewing angle range of −90°˜90°. That is, the maximum left viewing angle and the maximum right viewing angle are 90°, respectively. Curve 210 indicates the contrast ratio viewing angle characteristics of the LCD panel consisting of LC molecules with the 0.8° pre-title angle, and curve 220 indicates the contrast ratio of the LCD panel consisting of LC molecules with the 1.7° pre-title angle.

Referring to FIG. 2, in the LCD panel consisting of LC molecules with the high pre-title angle (1.7° pre-title angle), the contrast ratio is significantly reduced as the viewing angle increases. As a comparison, in the LCD panel consisting of LC molecules with the low pre-title angle (0.8° pre-title angle), the contrast ratio is smoothly reduced as the viewing angle increases.

Thus, to meet a predetermined contrast ratio requirement within a certain viewing angle range, the pre-tilt angle has to be reduced. However, as the pre-tilt angle decreases, the image retention may become severe. In addition, because an anchoring effect between the LC molecules and the alignment layer may be enhanced, i.e., an anchoring strength may be increased, a saturation voltage of driving the LC molecules to reorient may be increased. The saturation voltage may be referred as the RMS voltage corresponding to 90% normalized light transmission. Given a limited driving capability of a driving circuit, the light transmission of the LC layer may be reduced and the power consumption of the LCD panel may be increased.

According to the present disclosure, the problem of image retention in LCDs may be solved by changing the materials of the alignment layer, such that the alignment layer may provide a larger pre-tilt angle to each LC molecule in the LC layer.

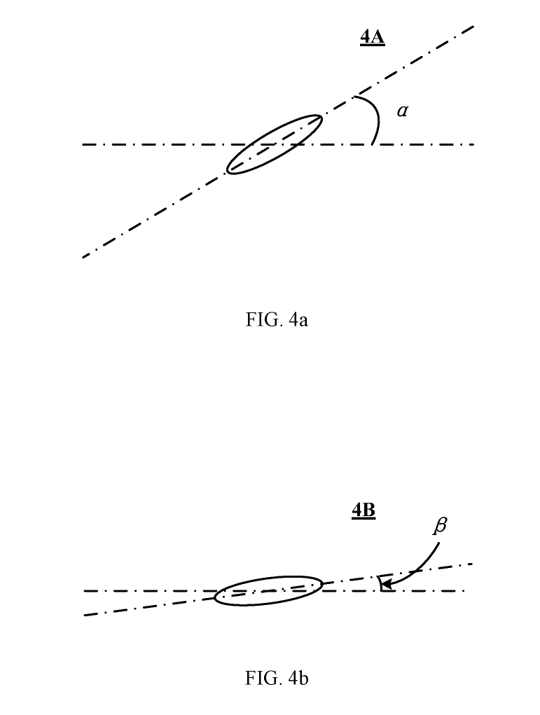

FIG. 3 illustrates a cross-sectional view of an exemplary LCD panel consistent with disclosed embodiments. As shown in FIG. 3, the LCD panel may include a first substrate 310, a second substrate 320 arranged opposite to the first substrate 310, and a liquid crystal (LC) layer 330 sandwiched between the second substrate 320 and the first substrate 310. An inner surface of the first substrate 310 may face an inner surface of the second substrate 320.

In one embodiment, the first substrate 310 may be an array substrate. The second substrate may be a color film substrate. A first alignment layer 311 may be disposed on the inner surface of the array substrate 310, which may provide a first pre-tilt angle α to LC molecules 331 in contact with the first alignment layer 311. A second alignment layer 321 may be disposed on the inner surface of the second substrate 320, which may provide a second pre-tilt angle β to LC molecules 332 in contact with the second alignment layer 321. In particular, α>β.

The LC molecules in the bulk of the LC layer may follow the LC molecules in contact with the first alignment layer 311 and the second alignment layer 321 to align. For example, as the LC molecules get far away from the first alignment layer 311, the pre-tilt angle of the LC molecules may gradually change from the first pre-tilt angle α to the second pre-tilt angle β. That is, as the LC molecules gradually approach the second alignment layer 321, the pre-tilt angle may gradually decrease.

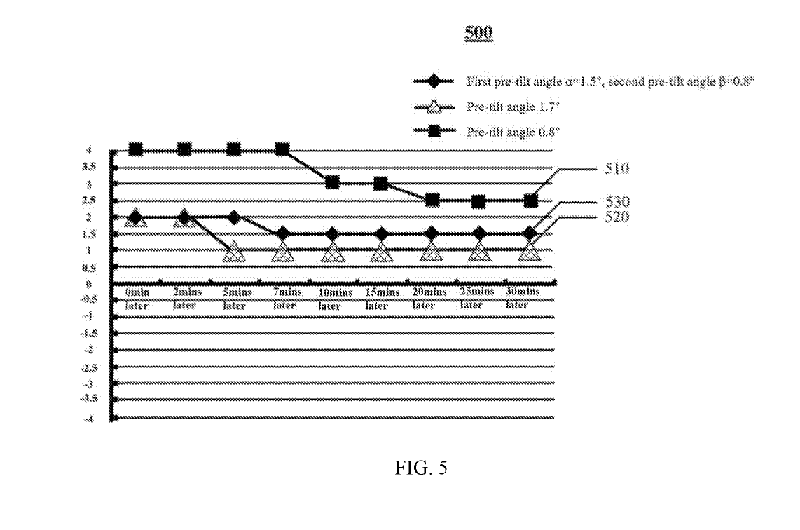

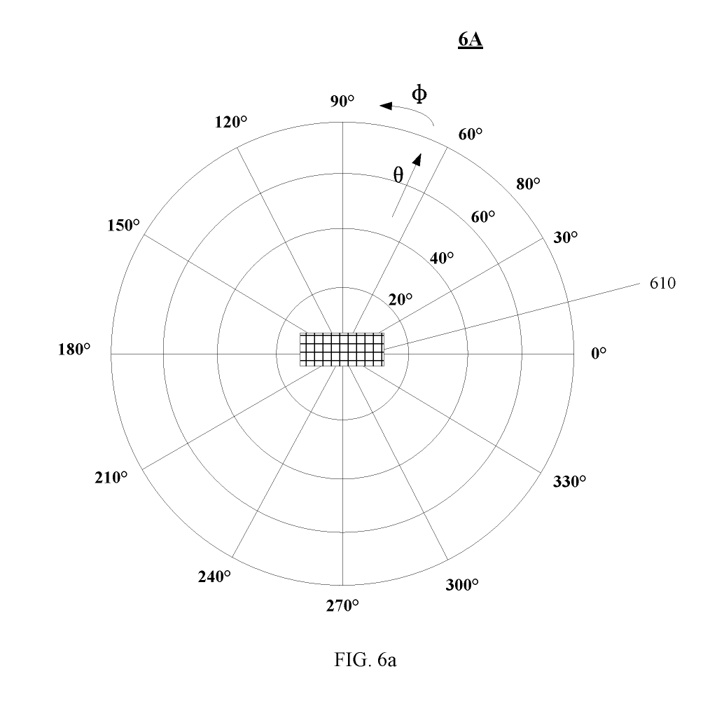

FIG. 4a illustrates a first pre-tilt angle provided by a first alignment layer in an exemplary LCD panel in FIG. 3 consistent with disclosed embodiments. FIG. 4b illustrates a second pre-tilt angle provided by a second alignment layer in an exemplary LCD panel in FIG. 3 consistent with disclosed embodiments. As shown in FIG. 4a and FIG. 4b, the first pre-tilt angle α may be larger than the second pre-tilt angle β.

The first pre-tilt angle α shown in FIG. 4a and the second pre-tilt angle β shown in FIG. 4b are only for illustrative purposes, illustrating a comparison between the first pre-tilt angle α and the second pre-tilt angle β. The size of the first pre-tilt angle α and the size of the second pre-tilt angle β may not be the actual sizes measured in FIG. 4a and FIG. 4b, respectively.

Returning to FIG. 3, in certain embodiments, an electrode layer (not shown) may be disposed on the array substrate 310, which may apply a lateral electric field to the LC layer 330. For example, the electrode layer may be disposed between the array substrate 310 and the first alignment layer 311. The electrode layer may be a pixel electrode layer including a plurality of pixel electrodes, a common electrode layer including a plurality of common electrodes, etc.

When the pixel electrodes and the common electrodes are applied with different voltages, a lateral electric field may be generated due to a voltage difference between the pixel electrodes and the common electrodes. Accordingly, the liquid crystal molecules in the liquid crystal layer 330 may be reoriented or tilted by the electric field. Thus, visible light emitted from a backlight source may transmit through the liquid crystal layer 330, and a displayed image may be observed by users. In particular, each electric fluxline of the electric field may have a segment parallel to the array substrate 310, and the electric field distribution throughout the LCD panel may not be uniform.

For example, the LCD panel may be operated in an in-plane switching (IPS) mode or a fringe field switching (FFS) mode, in which the electric-field-induced LC molecular reorientation mainly happens in the lateral direction. The IPS mode and FFS mode may satisfy the demand for better image quality such as wide viewing angle for multi-viewers, high resolution for Retina display, and pressure-resistance for touch screen. Thus, the IPS mode and the FFS mode are commonly used in mobile displays and high-end LCDs. The LCs in the LC layer may be positive or negative dielectric anisotropy LCs.

Further, because both the pixel electrode layer and the common electrode layer may be disposed on the array substrate 310, the LC molecules closer to the array substrate 310 may experience a larger electric field than the LC molecules away from the array substrate 310. Thus, the image retention level of the LCD panel may be more closely related to the first pre-tilt angle α provided to the LC molecules in the LC layer by the first alignment layer 311. Because when the LCD panel has been driven for a long period of time (usually ˜10 min to several hours), the ions may be trapped at the interface between the LC molecules and the alignment layer, and the density of the adsorbed ions may be proportional to the applied electric field.

When the first pre-tilt angle α increases, the image retention level (including both the high temperature image retention and low temperature image retention) of the LCD panel may decrease. Further, the increased first pre-tilt angle α may reduce the saturation voltage to reorient the LC molecules and, thus, reduce the power consumption of the LCD panel.

In the disclosed embodiments, the second pre-tilt angle β, which may be provided to the LC molecules in the LC layer 330 by the second alignment layer 321 disposed on the second substrate 320, may be smaller than the first pre-tilt angle α. Thus, the contrast ratio within a certain viewing angle range may be increased, such that the LC panel may exhibit a more desired image performance.

In certain embodiments, to configure the first pre-tilt angle α provided by the first alignment layer 311 to be different from the second pre-tilt angle β provided by the second alignment layer 321, the main chain or the long chain of molecules in materials (e.g., polyimide, PI) to fabricate the first alignment layer 311 and the second alignment layer 321 may be incorporated with different types and/or different numbers of alkyl groups.

For example, the first alignment layer 311 may be made of horizontal alignment materials capable of providing the first pre-tilt angle to the LC molecules in contact with the first alignment layer 311, and the second alignment layer 321 may be made of horizontal alignment materials capable of providing the second pre-tile angle to the LC molecules in contact with the second alignment layer 321. The horizontal alignment materials may induce the LC molecules in contact therewith to be homogeneously aligned, for example, at an angle of approximately 0-2° to the alignment layer surface.

The first pre-tilt angle α provided by the first alignment layer 311 to the LC molecules in the LC layer 330 may satisfy: 1.5°≦α≦2°. For example, the first pre-tilt angle α may be approximately 1.5°.

The second pre-tilt angle β provided by the second alignment layer 321 to the LC molecules in the LC layer 330 may satisfy: β≦1°. For example, the second pre-tilt angle β may be approximately 0.8°.

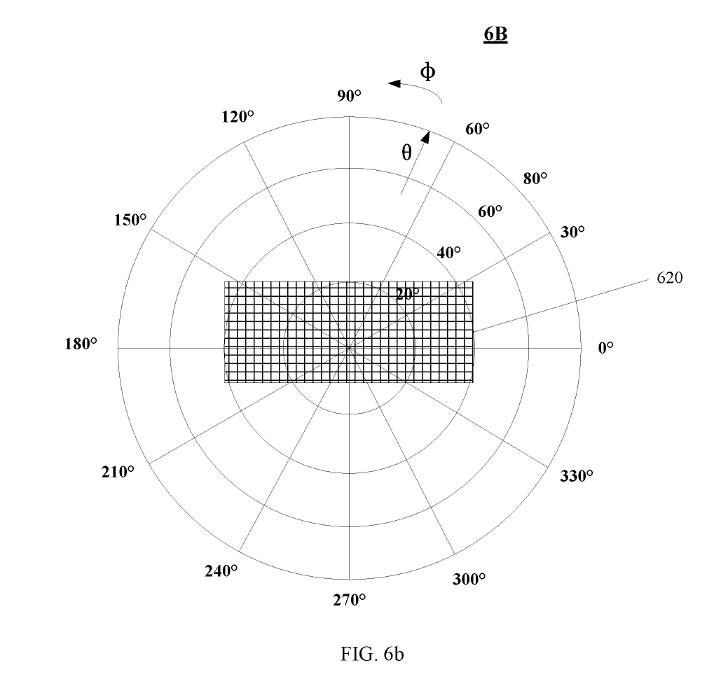

FIG. 5 illustrates high temperature (65° C./2 h) image retention curves of two LCD panels and an exemplary LCD panel consistent with disclosed embodiments. That is, the image retention curves are measured after the LCD panels and the disclosed LCD panel display a black-and-white checkerboard pattern for two hours in a 65° C. environment. The two LCD panels and the disclosed LCD panel are all 32-greyscale displays. As shown in FIG. 5, the horizontal axis indicates the time after the LCD panel stops displaying the black-and-white checkerboard pattern, and the vertical axis indicates the image retention level.

The curve 510 denotes the high temperature image retention curve of the LCD panel with the 0.8° pre-tilt angle, the curve 520 denotes the high temperature image retention curve of the LCD panel with the 1.7° pre-tilt angle, and the curve 530 denotes the high temperature image retention curve of the disclosed LCD panel with the 1.5° first pre-tilt angle α (i.e., α=1.5°) and the 0.8° second pre-tilt angle β (i.e., β=0.8°).

According to a comparison between the curve 510 and the curve 530, the disclosed LCD panel may always exhibit a smaller image retention (i.e., a lower image retention level) than the LCD panel with the 0.8° pre-tilt angle.

According to a comparison between the curve 520 and the curve 530, the LCD panel with the 1.7° pre-tilt angle and the disclosed LCD panel may exhibit a same image retention level during a time period from “0 mins later” to “2 mins later”. The image retention level may be a second image retention level, indicating a minor image retention. After the first 2 mins, the disclosed LCD panel may exhibit a higher image retention level than the LCD panel with the 1.7° pre-tilt angle.

Table 1 illustrates viewing angle contrast ratios (CR) of the LCD panel with the 0.8° pre-tilt angle, the LCD panel with the 1.7° pre-tilt angle, and the disclosed LCD panel with the 1.5° first pre-tilt angle α and the 0.8° second pre-tilt angle β. As indicated in Table 1, the viewing angle CR indicates the contrast ratio (CR) within a certain viewing angle range. Bmin, Amin and A+min indicate the lowest CR within a certain viewing angle range, respectively.

TABLE 1
Viewing angle contrast ratio

| Viewing | Pre-tilt | | |
|---|---|---|---|
| angle CR | angle = 0.8° | Pre-tilt angle = 1.7° | α = 1.5°, β = 0.8° |
| Bmin | 390 | 273 | 332 |
| Amin | 532 | 365 | 449 |
| A + min | 816 | 807 | 812 |

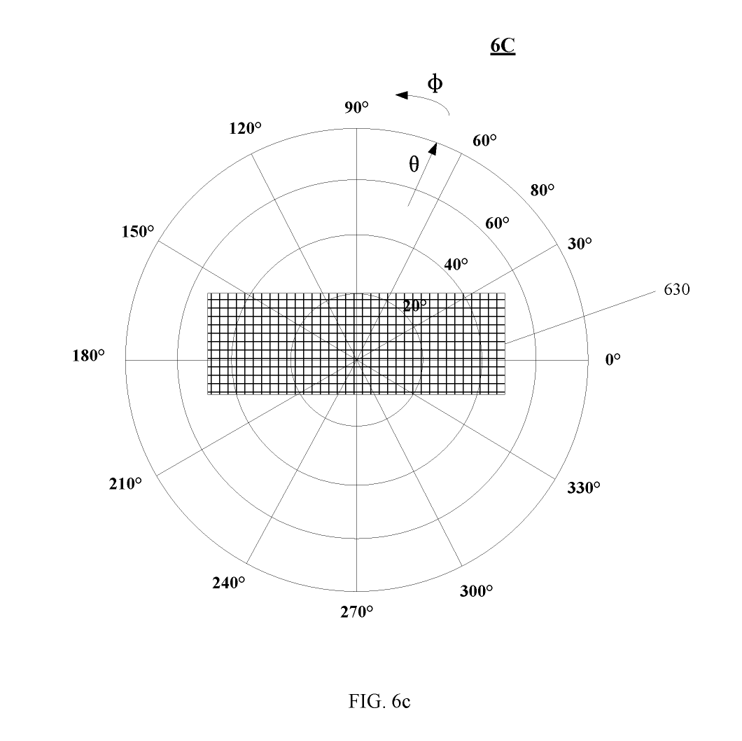

FIGS. 6a-6c illustrate viewing cones corresponding to contrast ratio Bmin, Amin and A+min in a polar coordinate system. As shown in FIGS. 6a-6c, a central angle Φ indicates a rotating angle within the surface of the LCD panel starting from a preset reference position. Angle θ represented by concentric circles or the radial distance from the origin indicates the top viewing angle, the bottom viewing angle, the left viewing angle or the right viewing angle.

The central angle Φ may be referred as an azimuthal angle Φ, and the angle θ represented by the concentric circles may be referred as an angle of inclination θ. In the polar coordinate system, every point may correspond to one viewing direction. The viewing directions may be indicated by the angle of inclination θ and the azimuthal angle Φ. The angle of inclination θ is measured from the surface normal of the LCD panel, and the azimuthal angle Φ is measured as the angle between the projection of the viewing direction on the surface of the LCD panel and the preset reference position. Thus, a viewing cone (range of viewing angles) may be defined by a locus (a closed line) in the polar coordinate system, as indicated by a grid 610, a gird 620 and a grid 630.

Referring to Table 1 and FIGS. 6a-6c, Bmin indicates the lowest CR within a viewing cone of −10° left viewing angle, 10° right viewing angle, 8° top viewing angle, and 4° bottom viewing angle (denoted by the grid 610 in FIG. 6a). Amin represents the lowest CR within a viewing cone of −40° left viewing angle, 40° right viewing angle, 20° top viewing angle, and 10° bottom viewing angle (denoted by the grid 620 in FIG. 6b). A+min represents the lowest CR within a viewing cone of −50° left viewing angle, 50° right viewing angle, 20° top viewing angle, and 10° bottom viewing angle (denoted by the grid 630 in FIG. 6c)

As indicated in Table 1, the disclosed LCD panel may exhibit a higher viewing angle CR than the LCD panel with the 1.7° pre-tilt angle within each viewing cone. That is, the Bmin, Amin, and A+min of the disclosed LCD panel may be higher than the Bmin, Amin, and A+min of the LCD panel with the 1.7° pre-tilt angle, respectively. In particular, compared with the LCD panel with the 1.7° pre-tilt angle, the Bmin, Amin, and A+min of the disclosed LCD panel may be improved by 21%, 23% and 6%, respectively.

On the other hand, the disclosed LCD panel may exhibit a slightly lower viewing angle CR than the LCD panel with the 0.8° pre-tilt angle within each viewing cone. That is, the Bmin, Amin, and A+min of the disclosed LCD panel may be lower than the Bmin, Amin, and A+min of the LCD panel with the 0.8° pre-tilt angle, respectively. In particular, compared with the LCD panel with the 0.8° pre-tilt angle, the Bmin, Amin, and A+min of the disclosed LCD panel may only be reduced by 14%, 18% and 4%, respectively.

Table 2 illustrates saturation voltages of the LCD panel with the 0.8° pre-tilt angle, the LCD panel with the 1.7° pre-tilt angle, and the disclosed LCD panel with the 1.5° first pre-tilt angle α and the 0.8° second pre-tilt angle β.

TABLE 2
Saturation voltage (V)

| | Pre-tilt | Pre-tilt | |
|---|---|---|---|
| | angle = 0.8° | angle = 1.7° | α = 1.5°, β = 0.8° |
| Saturation voltage | 6.2 | 5.6 | 5.8 |
| (V) | | | |

As indicated in Table 2, the saturation voltage of the disclosed LCD panel may be 7% lower than the saturation voltage of the LCD panel with the 0.8° pre-tilt angle, but only 3.5% higher than the saturation voltage of the LCD panel with the 1.7° pre-tilt angle.

From the above discussion, the LCD panel with the 1.5° first pre-tilt angle α and the 0.8° second pre-tilt angle β may be able to balance the image retention level, the contrast ratio in a given viewing angle and the saturation voltage. Thus, a lower image retention level, a larger viewing angle range (or a larger viewing cone) and a smaller saturation voltage may be realized at the same time.

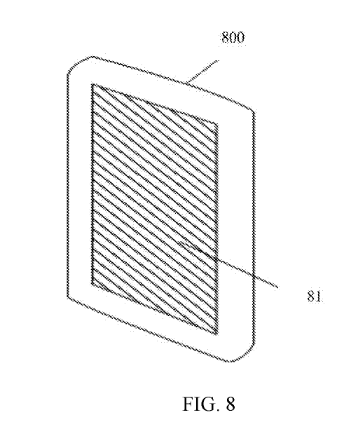

The present disclosure further provides a display device including the disclosed LCD panel. FIG. 8 illustrates a schematic diagram of an exemplary display device consistent with disclosed embodiments. As shown in FIG. 8, the display device 800 may include the disclosed LCD panel 81 and other well-known components, e.g., a driving circuit, a plurality of data lines providing data signals to the pixel electrodes in the LCD panel, a plurality of scanning lines providing scanning signals to the pixel electrodes in the LCD panel, etc. The detail structure of these well-known components in the display device may not be repeated here.

The display device 800 may be a tablet including the disclosed LCD panel. The display device may also be a TV, a smartphone, a notebook, and a smartwatch the disclosed LCD panel, etc. Further, the display device may be any appropriate type of content-presentation devices comprising the disclosed LCD panel.

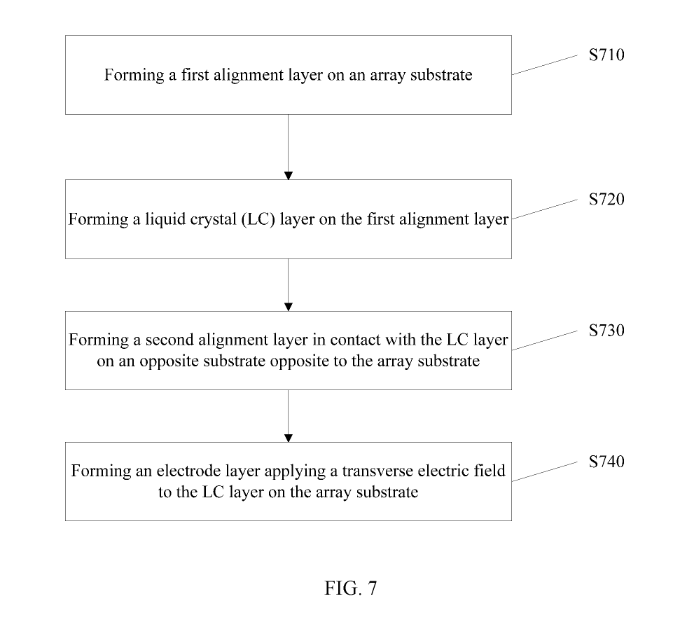

FIG. 7 illustrates a flow chart of an exemplary LCD panel fabrication process consistent with disclosed embodiments. As shown in FIG. 7, the LCD panel fabrication process 700 may include the following steps.

Step S710: forming a first alignment layer on an array substrate.

Step S720: forming a liquid crystal (LC) layer on the first alignment layer.

Step S730: forming a second alignment layer in contact with the LC layer on a second substrate opposite to the array substrate.

In one embodiment, the first substrate may be an array substrate. The second substrate may be a color film substrate. In particular, the first alignment layer may be may provide the first pre-tilt angle α to the LC molecules in the LC layer, and the second alignment layer may provide the second pre-tilt angle β to the LC molecules in the LC layer, where α>β.

In certain embodiments, the LCD panel fabrication method 700 may further include Step S740: forming an electrode layer applying a lateral electric field to the LC layer on the array substrate.

It should be noted that, the order of the steps S710-S740 shown in FIG. 7 is only for illustrative purposes, and is not intended to limit the scope of the present invention. In practical manufacturing, the steps S710-S740 may be performed in a different order. Any LCD panel fabrication method including the disclosed steps S710-S740 is within the scope of the present invention.

In certain embodiments, the first alignment layer may provide the first pre-tilt angle α to the LC molecules in the LC layer, the first pre-tilt angle α may satisfy: 1.5°≦α≦2°. In one embodiment, the first pre-tilt angle α may be approximately 1.5°.

In certain embodiments, the second alignment layer may provide the second pre-tilt angle α to the LC molecules in the LC layer, the second pre-tilt angle β may satisfy: β≦1°. In one embodiment, the second pre-tilt angle β may be approximately 0.8°.

The LCD panel fabricated by the disclosed LCD panel fabrication method may be able to balance the image retention level and the viewing angle range, achieving a lower image retention level and a larger viewing angle at the same time.

The description of the disclosed embodiments is provided to illustrate the present invention to those skilled in the art. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A liquid crystal display (LCD) panel, comprising:
a first substrate;
a second substrate arranged opposite to the first substrate;
a liquid crystal (LC) layer sandwiched between the first substrate and the second substrate;
a first alignment layer disposed on the first substrate, wherein the first alignment layer is in contact with the LC layer and provides a first pre-tilt angle α to LC molecules in the LC layer; and
a second alignment layer disposed on the second substrate, wherein the second alignment layer is in contact with the LC layer and provides a second pre-tilt angle β to the LC molecules in the LC layer, and α>β.

2. The LCD panel according to claim 1, wherein:
the first substrate is an array substrate.

3. The LCD panel according to claim 2, further including:
an electrode layer disposed on the array substrate applying a lateral electric field to the LC layer.

4. The LCD panel according to claim 1, wherein:
the first pre-tilt angle α satisfies 1.5°≦α≦2°.

5. The LCD panel according to claim 4, wherein:
the first pre-tilt angle α is approximately 1.5°.

6. The LCD panel according to claim 4, wherein:
the second pre-tilt angle β satisfies β≦1°.

7. The LCD panel according to claim 6, wherein:
the second pre-tilt angle β is approximately 0.8°.

8. A display device, comprising:
a liquid crystal display (LCD) panel,
wherein the LCD comprises a first substrate,
a second substrate arranged opposite to the first substrate,
a liquid crystal (LC) layer sandwiched between the second substrate and the first substrate,
a first alignment layer disposed on the first substrate, wherein the first alignment layer is in contact with the LC layer and provides a first pre-tilt angle α to LC molecules in the LC layer, and
a second alignment layer disposed on the second substrate, wherein the second alignment layer is in contact with the LC layer and provides a second pre-tilt angle β to the LC molecules in the LC layer, and α>β.

9. The display device according to claim 8, wherein:
the first substrate is an array substrate.

10. The display device according to claim 9, wherein:
the first pre-tilt angle α satisfies 1.5°≦α≦2°.

11. The display device according to claim 10, wherein:
the first pre-tilt angle α is approximately 1.5°.

12. The display device according to claim 10, wherein:
the second pre-tilt angle β satisfies β≦1°.

13. The display device according to claim 12, wherein:
the second pre-tilt angle β is approximately 0.8°.

14. A liquid crystal display (LCD) panel fabrication method, comprising:
forming a first alignment layer on a first substrate;
forming a liquid crystal (LC) layer on the first alignment layer; and
forming a second alignment layer in contact with the LC layer on a second substrate opposite to the first substrate,
wherein the first alignment layer provides a first pre-tilt angle α to LC molecules in the LC layer, the second alignment layer provides a second pre-tilt angle β to the LC molecules in the LC layer, and α>β.

15. The LCD panel fabrication method according to claim 14, wherein:
the first substrate is an array substrate.

16. The LCD panel fabrication method according to claim 15, further including:
forming an electrode layer on the array substrate, wherein the electrode layer applies a lateral electric field to the LC layer.

17. The LCD panel fabrication method according to claim 15, wherein:
the first pre-tilt angle α satisfies 1.5°≦α≦2°.

18. The LCD panel fabrication method according to claim 17, wherein:
the first pre-tilt angle α is approximately 1.5°.

19. The LCD panel fabrication method according to claim 17, wherein:
the second pre-tilt angle β satisfies β≦1°.

20. The LCD panel fabrication method according to claim 19, wherein:
the second pre-tilt angle β is approximately 0.8°.
